(19) United States
(12) Patent Application Publication
(10) Pub. No.: US 2015/0000154 A1
(43) Pub. Date: Jan. 1, 2015

(54) DRYER HAVING WOVEN WIRE BELT CONVEYOR SYSTEM

(71) Applicant: BUHLER AEROGLIDE CORPORATION, Cary, NC (US)

(72) Inventors: Steve Blackowiak, Clayton, NC (US); Shannon Ford, Sanford, NC (US); Justin M. Schreiber, Raleigh, NC (US)

(73) Assignee: BUHLER AEROGLIDE CORPORATION, CARY, NC (US)

(21) Appl. No.: 14/316,110

(22) Filed: Jun. 26, 2014

Related U.S. Application Data
(60) Provisional application No. 61/841,451, filed on Jul. 1, 2013.

(51) Int. Cl. F26B 15/00; F26B 21/00; F26B 23/02

(52) U.S. Cl. CPC F26B 15/00; F26B 23/02; F26B 21/00
USPC 34/443; 34/201

(57) ABSTRACT

A dryer includes a housing and a woven wire belt conveyor assembly that extends through a drying chamber of the dryer. The woven wire belt is trained around a drive drum and a tensioning drum. To support the woven wire belt, there is provided a plurality of removable rollers or supports that engage the woven wire belt and support the same as the woven wire belt is driven through the drying chamber.

### FIELD OF THE INVENTION

The present invention relates to commercial or industrial dryers.

### BACKGROUND OF THE INVENTION

Commercial and industrial dryers are used today to dry various products including food products. Dryers that are used for drying food products must be cleaned periodically and must meet high sanitation standards. Often in conventional dryers, the structural design of dryers and components used in dryers are not designed to minimize sanitation risks. That is, some parts and subassemblies of dryers are difficult and time-consuming to clean. For example, many conveyor assemblies utilized in dryers include chains which present a substantial sanitation risk. Furthermore, traveling guides secured on conveyor assemblies also attract small particles which are difficult to dislodge during cleaning. In addition, conventional conveyors often include bed plates or panels hinged together by hinge pins. These hinged structures also include areas where products fragments and other debris can accumulate. These areas too are difficult to thoroughly clean.

### SUMMARY

The present invention entails a dryer having a housing, drying chamber, a burner unit and a fan for circulating heated air through the drying chamber. A chainless conveyor assembly is disposed within the drying chamber for moving the product through the drying chamber. The chainless conveyor assembly includes an endless woven wire belt, a drive drum disposed at one end of the conveyor assembly and having the woven wire belt trained thereround for driving the endless woven belt and a tensioning drum disposed on the other end of the chainless conveyor assembly for tensioning the woven wire belt.

In one embodiment, the woven wire belt is supported by removable support rollers that support both the upper run and lower run of the woven wire belt. In addition, there may be provided removable edge supports that project inwardly from opposite sides of the conveyor assembly to engage and support opposed outer edges of the upper run of the woven wire belt.

The present invention also entails a method of drying a product in a dryer having a drying chamber and a woven wire belt for moving the product through the drying chamber. The method includes placing the product to be dried on the woven wire belt and moving the woven wire belt through the drying chamber of the dryer. Further, the method entails circulating a system of heated air through the drying chamber and directing at least a portion of the heated system of air through the woven wire belt such that air passes between woven strands of wire and in the process contacts the product supported on the woven wire belt and dries the product.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of a drying system.

FIG. 2 is a side elevational view of the drying system shown in FIG. 1 with side panels or doors removed to better illustrate the internal structure of the drying system.

FIG. 3 is a cross-sectional view along the line III-III in FIG. 2.

FIG. 4 is a fragmentary perspective view showing a portion of the conveyor system employed in the dryer.

FIG. 5 is a fragmentary perspective view showing components that are utilized to support the conveyor system.

FIGS. 6A and 6B show a device for supporting the outer edges of the upper run of the conveyor.

FIG. 7 is a fragmentary cross-sectional view showing a portion of the conveyor assembly.

FIGS. 8A and 8B are fragmentary sectional views showing the side retainer of the conveyor assembly.

FIG. 9 is a fragmentary perspective view showing the back side of a side retainer and the dovetail connection between the side retainer and a pivoting bracket.

FIG. 10 is a top plan view of a portion of the woven wire belt.

FIG. 11 is a fragmentary sectional view showing the woven wire belt supported by an upper roller with the rings of the upper roller engaged in shallow channels formed on the underside of the woven wire belt.

FIG. 12 is a schematic illustration of the drive drum and tensioning roller or drum that forms a part of the conveyor assembly of the present invention.

FIG. 13 is a fragmentary cross sectional view showing the upper and lower runs of the woven wire belt.

### DESCRIPTION OF EXAMPLARY EMBODIMENT

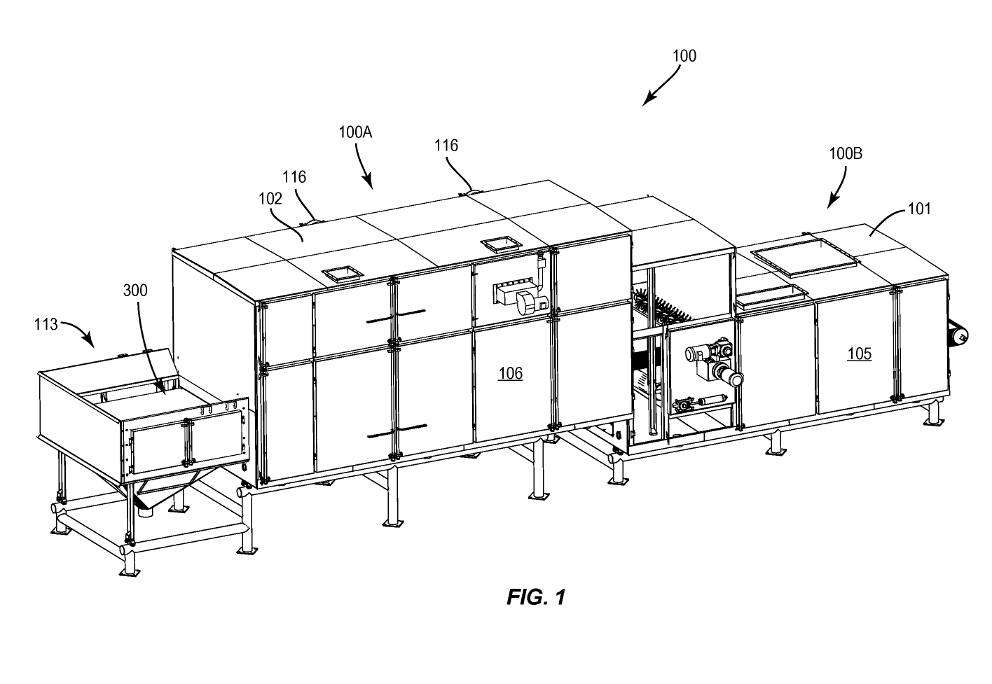

With further reference to the drawings, the dryer of the present invention is shown therein. In FIG. 1, a drying system indicated generally by the numeral 100 is shown. Drying system 100 includes a dryer or drying section indicated generally by the numeral 100A and a cooler or cooling section 100B. Dryer 100A is a commercial or industrial dryer that is utilized to dry a wide variety of products, particularly food products such as cereal, grains, fruits and vegetables, as well as animal feed. Details of the dryer 100A are not dealt with herein because such is not per se material to the present invention and because dryers of the type shown in FIGS. 1-3 and discussed herein are well known and appreciated by those skilled in the art.

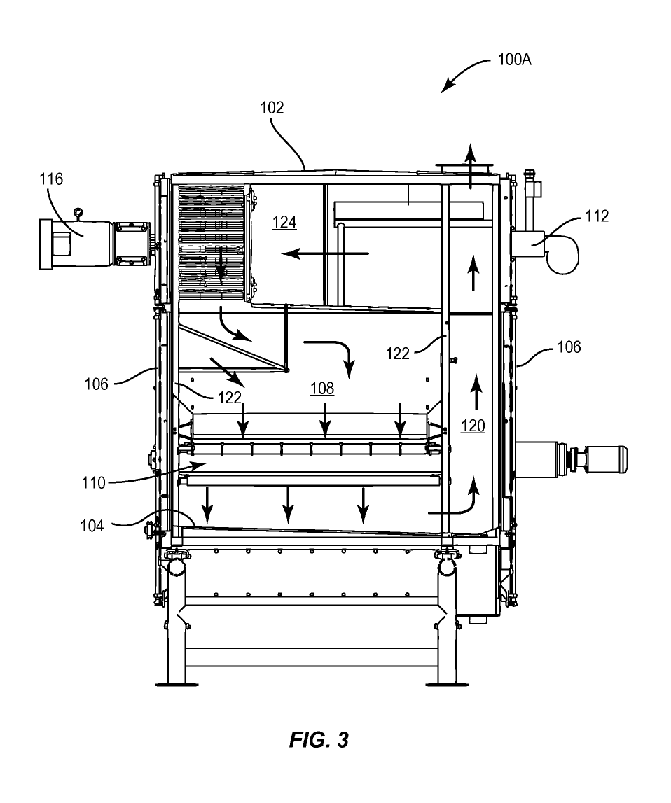

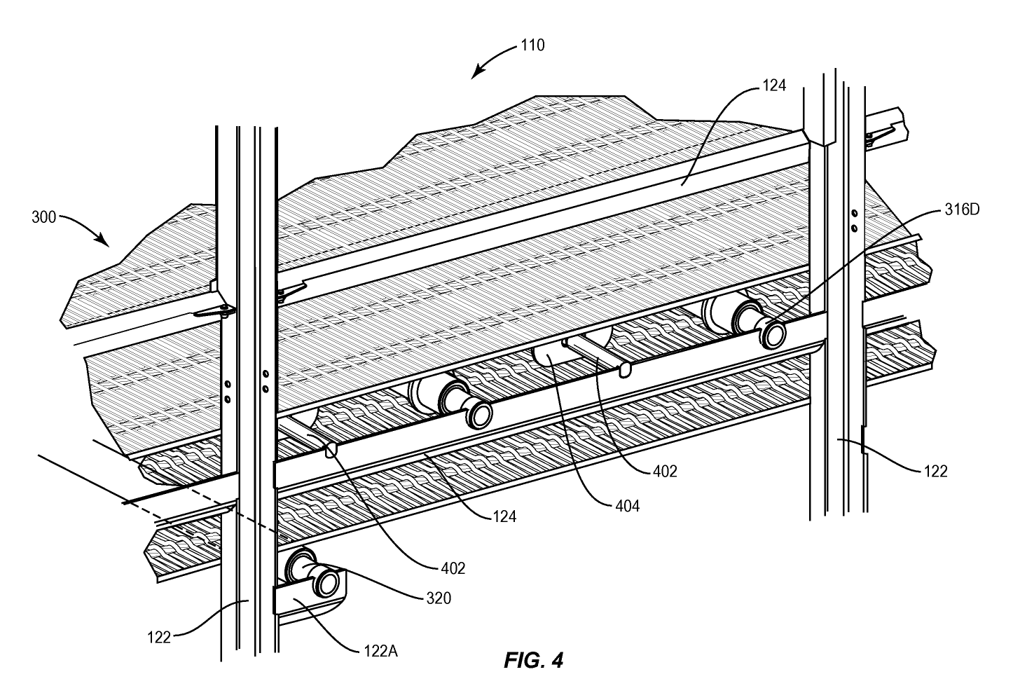

A brief discussion, however, of the dryer 100A is in order. Dryer 100A, in this example, comprises a housing structure that includes a roof 102 and a floor structure 104. See FIG. 3. Further the housing of the dryer includes side panels or doors indicated by the numeral 106. Opposed ends of the dryer 100A are generally closed. There is provided various internal support structures within the dryer 100A that are employed to support a conveyor assembly, indicated generally by the numeral 110, as well as the roof restructure 102. In particular, as illustrated in FIGS. 3 and 4, there is a plurality of vertical supports 122 (formed vertical frame members) disposed interiorly within the dryer 100A. Vertical support members 122 are laterally spaced in the dryer and, in this case, there is provided two rows of the vertical support members with the vertical support members in each row being longitudinally spaced apart.

Formed internally within the dryer 100A is a drying or conditioning chamber 108. Drying or conditioning chamber 108 includes the conveyor assembly 110 referred to above.

Dryer 100A also includes a system for generating and circulating a system of heated or conditioned air through the dryer. In this regard, disposed about an upper side portion of the dryer 100A is a burner unit 112. Disposed adjacent the burner unit 112 is a filtered air inlet. Disposed across from the burner unit 112 is an air recirculating fan assembly 116. As illustrated in FIG. 3, the burner unit 112 generates heat and heats a system of air that moves across the burner unit and through an upper plenum 124 of the dryer. As shown in FIG. 3, heated air moves downwardly through the drying chamber 108. Once in the drying chamber 108, the heated air moves downwardly through the conveyor assembly 110 and, at the bottom of the dryer 110, turns to the right, as viewed in FIG. 3, and moves into a right plenum 120. From the right plenum 120, air moves upwardly and a portion of the air circulated through the dryer 100A is exhausted. Another portion of the air is recirculated through the dryer 100A in conventional fashion.

Persons skilled in the art will understand that various air flow patterns can be formed in dryers of the type shown in FIGS. 1-3. More particularly, the dryer 100A, in some embodiments, is designed to include a number of interchangeable panels that permit air flow to be directed in various directions through the drying chamber 108. Thus, the air pattern through the drying chamber 108 can be varied or reversed by simply rearranging panels within the dryer 100A. For example, in some cases, the heated air can be directed to a lower portion of the dryer and then upwardly through the conveyor assembly 110. For a more complete and unified understanding of the basic structure, function and operation of conventional dryers, one is referred to dryers manufactured and sold by Buhler Aeroglide Corporation, headquartered in Cary, N.C., USA.

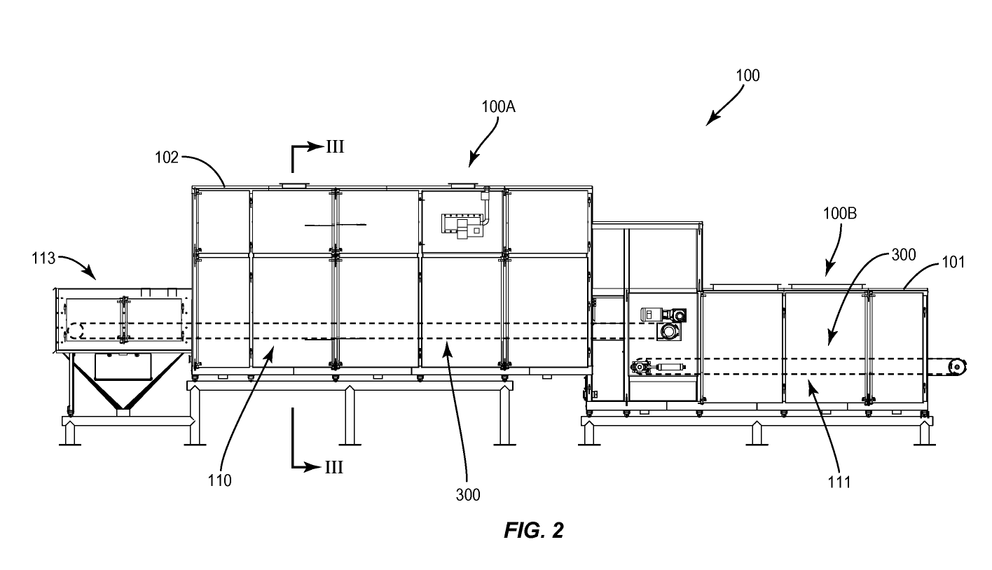

As noted above, integrated into the dryer 100A is a cooling section or cooling chamber 100B. Cooling chamber 100B includes a housing that comprises a roof 101 and side panels or doors 105. Disposed in the cooling chamber 100B is a conveyor assembly 111. See FIG. 2. Dried product from the conveyor assembly 110 is transferred to an inlet portion of the conveyor assembly 111. In conventional fashion, product received by the conveyor assembly 111 is moved through the cooling chamber 100B for the purpose of cooling the product. Details of the cooling chamber 100B are not dealt with herein because such is not per se material to the present invention and because cooling chambers of the general type shown in FIGS. 1 and 2 are well known and appreciated by those skilled in the art.

As discussed above, drying system 100 is provided with two or more conveyor assemblies for transferring product through the dryer 100A as well as the cooling section 100B. In the case of the embodiment illustrated herein, the basic designs for the various conveyor assemblies utilized in the drying system 100 are the same. That is, as viewed in FIG. 2, both conveyor assemblies 110 and 111 are of the same general design. As will be seen from the drawings and realized from the following discussion, the conveyor assemblies 110 and 111 are designed to reduce sanitation risks in dryer. In the case of the conveyor assembly 110 in the dryer 100A, it is noted that this conveyor assembly includes an inlet portion that projects outwardly from the dryer. This is the portion of the conveyor assembly 110 that projects outwardly from the left side of the dryer 100A as viewed in FIG. 2. This inlet portion of the conveyor assembly 110 projects into a hopper indicated generally by the numeral 113. Hopper 113 is utilized to receive product and transfer product to the inlet end of the conveyor assembly 110.

Forming a part of the conveyor assembly 110 is a flexible woven wire belt indicated generally by the numeral 300. The flexible woven wire belt 300 supports product being dried by the dryer. It is comprised of strands of wire woven together. The strands are closely spaced and are connected together in such a fashion that the belt 300 can flex. Spacing between respective wires forming the belt 300 enable air to pass through the belt.

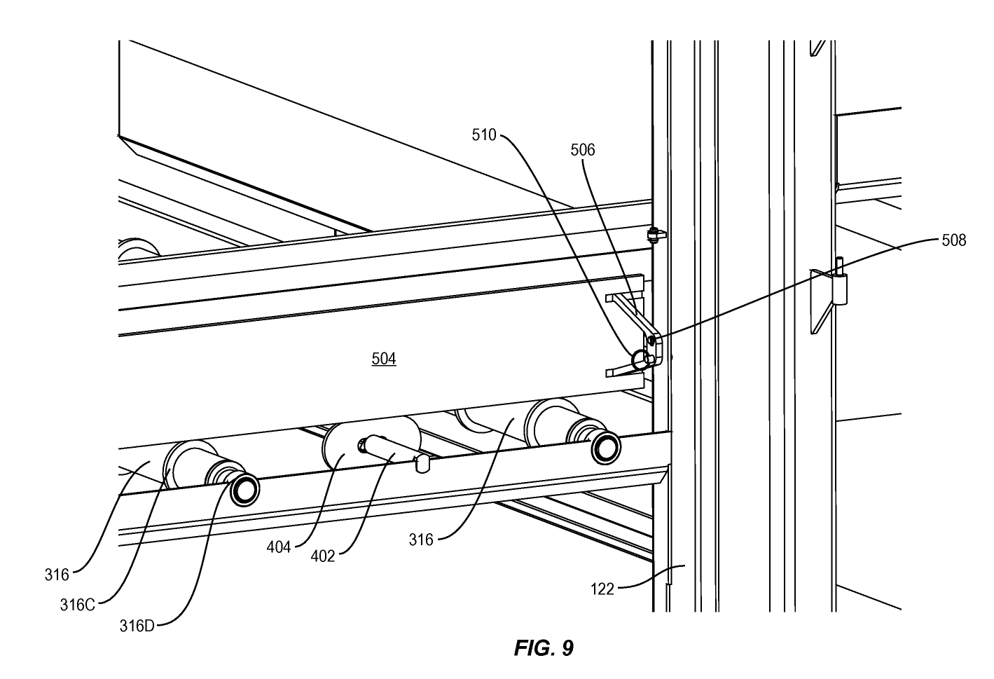

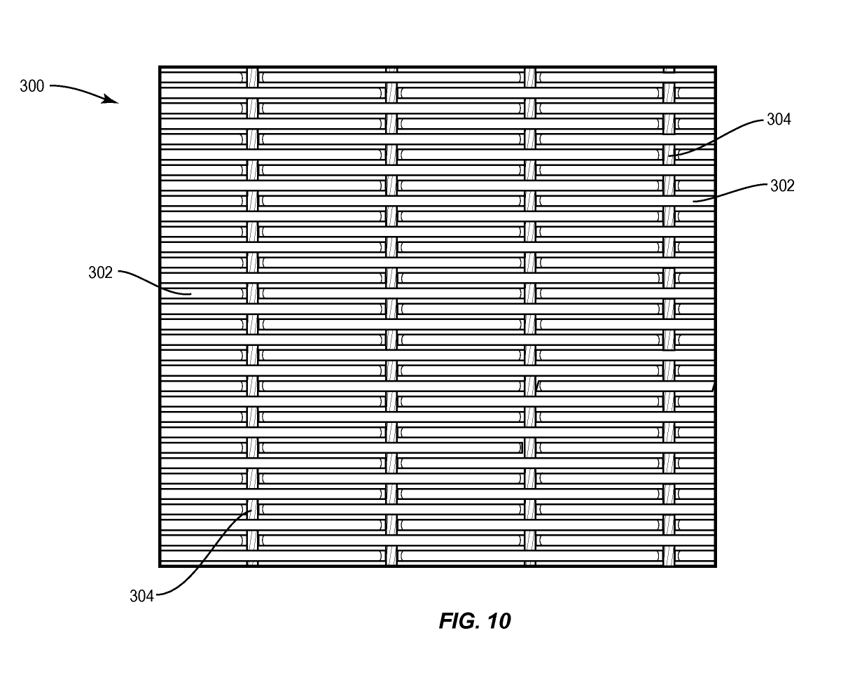

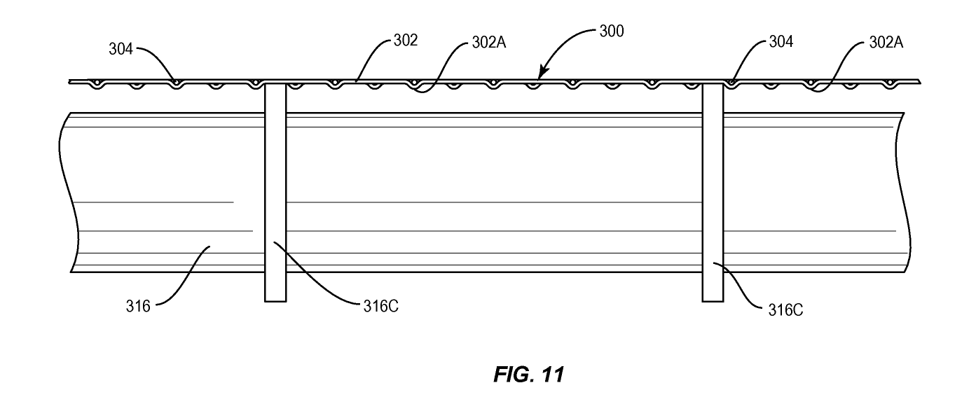

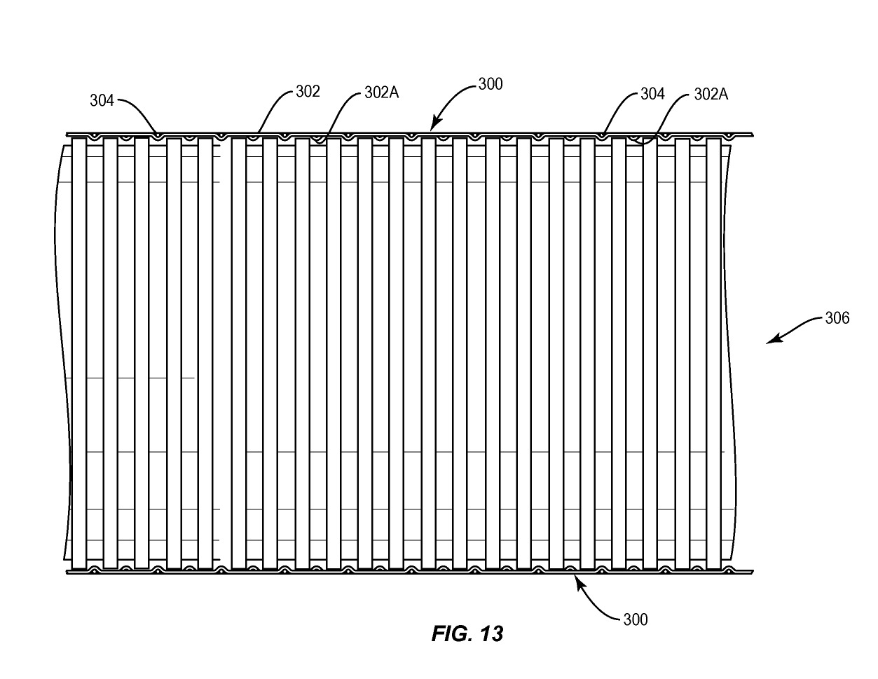

In the case of the embodiment illustrated herein, the wire belt 300 includes a multiplicity of warp wires 302 that are spaced in side-by-side relationship. See FIGS. 10, 11 and 13. Warp wires 302 extend transversely across the conveyor assembly 110 and are longitudinally spaced. Warp wires 302 form the upper surface of the conveyor belt 300. Warp wires 302 are woven into weft wires 304 formed on the bottom of the conveyor belt 300. Note that the weft wires are laterally spaced apart and extend longitudinally along the length of the wire belt 300. See FIGS. 10, 11 and 13. As noted above, the warp wires 302 are woven into the weft wires 304. Thus the warp wires 302 tend to undulate and form U-shaped segments 302A that extend downwardly and around the weft wires 304. See FIG. 11. Note that every other warp wire 304 is woven around specific weft wires 304. That is, not all warp wires 302 are woven into each weft wire 304. As viewed in FIGS. 9, 10 and 11, every other warp wire 302, in this embodiment, is woven into a particular weft wire 304. Some of the warp wires 302 are connected at opposite ends. In one embodiment, for example, two adjacent warp wires 302 are connected at their opposed ends while the next two warp wires are unconnected at their opposed ends. This tends to make the conveyor belt 300 as a whole more flexible.

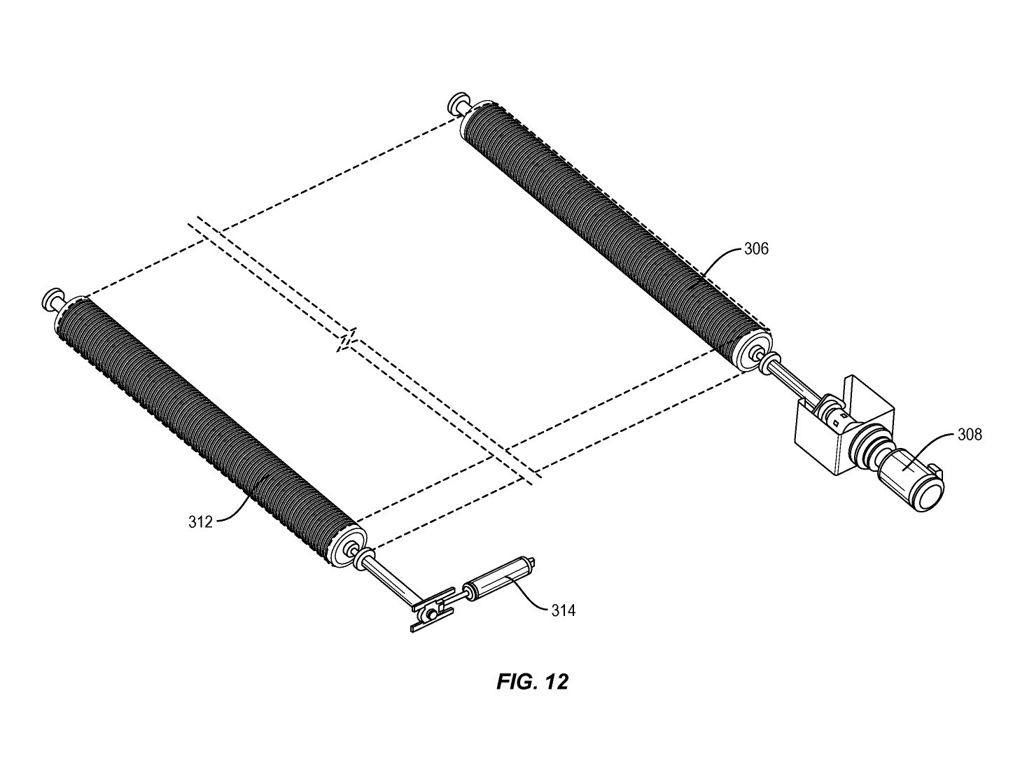

Flexible woven wire belt 300 is trained around a drive drum 306 at one end of the conveyor assembly 110. The outer surface of the drive drum 306 includes grooves that are spaced to receive the U-shaped segments 302A of belt 300 that are formed about the underside of the belt. That is, as the woven wire belt 300 travels around the drive drum 306, the U-shaped segments 302A align with these grooves and seat in the grooves as the belt moves around the drive drum. This feature functions to maintain the woven wire conveyor belt 300 in alignment with the drive drum 306. Drive drum 306 is driven by an electric motor 308. Various drive arrangements can be employed to cause the electric motor 308 to drive the drive drum. In one case, there may be a right angle or planetary style gear box utilized with the motor 308 in order to drive the drive drum 306. Driving torque from the motor 308 is transferred to a drive shaft of the drive drum 306 in the arrangement shown in FIG. 12. Drive drum 306 is mounted on frame structure forming a part of the dryer 100.

Secured on the other end of the conveyor assembly 110 is a tensioning or idler drum 312. Tensioning drum 312 likewise is mounted to frame structure of the dryer. A pair of pneumatic cylinders 314 (only one of which is shown) are mounted on opposite sides of the conveyor assembly 110 and are operatively connected to the tensioning drum 312 for maintaining an appropriate tension on the woven wire belt 300.

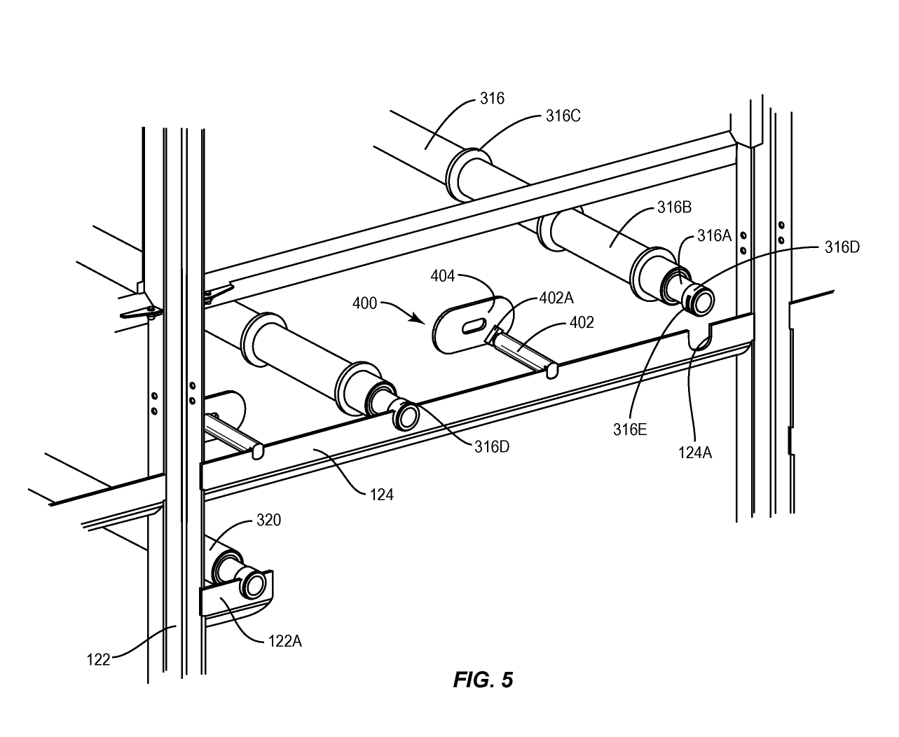

The upper run of the woven wire belt 300 is supported by a series of longitudinally spaced support rollers 316. See FIGS. 4 and 5. Support rollers 316 lie underneath the upper run of the wire belt 300 and serve to support the wire belt as the wire belt runs over the upper surfaces of the support rollers. Support rollers 316 are supported on a pair of spaced apart support rails 124. Support rails 124 are laterally spaced and extend longitudinally through the drying chamber 108. Further, support rails 124 are mounted to the vertical frame members 122.

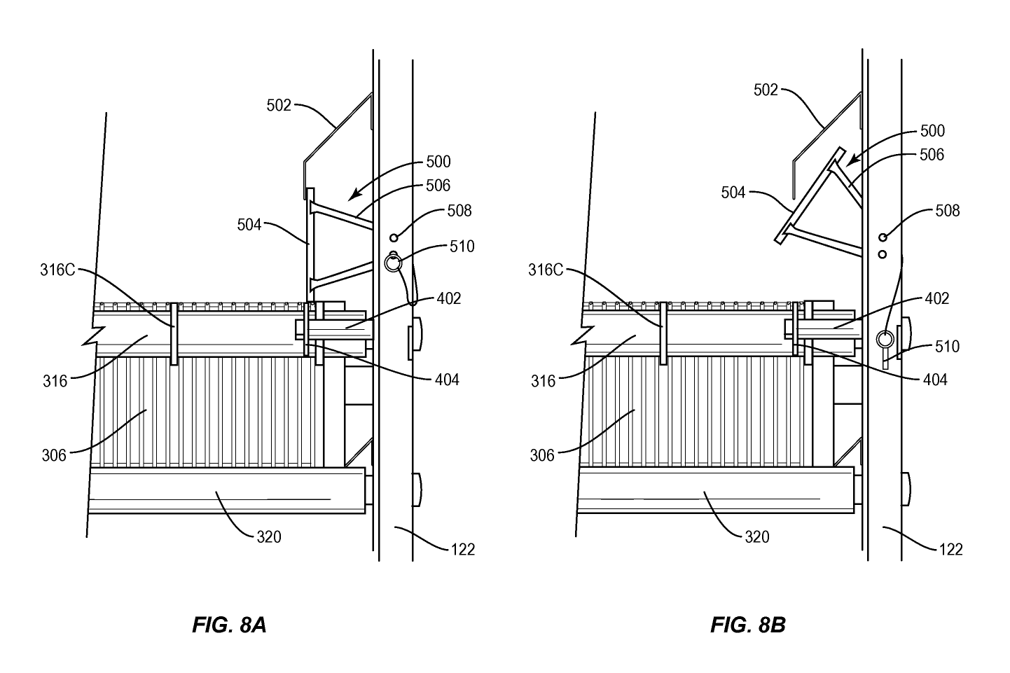

With further reference to FIGS. 4 and 5, details of the support rollers 316 are shown therein. Note that each support roller 316 includes a main body which includes a stub shaft 316A. Each roller 316 includes an outer surface 316B and a series of laterally spaced guide rings 316. Note in FIGS. 8A, 8B and 11 where the guide rings 316C align with selected shallow channels formed by the U-shaped segments 302A and the weft wires 304. That is, the rings 316C are designed to run in the space or channel defined between two adjacent weft wires 304 and the U-shaped segments 302A of the warp wires 302 that extend downwardly and around the weft wires. This contributes to maintaining the woven wire belt 300 in alignment.

Continuing to refer to FIGS. 4 and 5, each end of a respective roller 316 includes a flange bushing assembly 316D. In the embodiment illustrated herein, the flange bushing assembly 316 includes a self-lubricating bushing secured on the shaft 316A of the roller 316. Surrounding the bushing is a housing that includes a generally U-shaped slot 316E. See FIGS. 4 and 5. As noted above, the bushing in one embodiment is a plastic bushing that is generally self-lubricating. Shaft 316A of the roller is inserted into the bushing and rotates within the bushing. The bushing itself is pressed into the housing such that the bushing is tightly held in the housing. This enables the shaft 316A of the roller to freely rotate within the bushing. U-shaped slot 316E formed in the flange bushing assembly 316 is designed to seat within a U-shaped cut-out 124A formed in the support rail 124. It thusly follows that the rollers 316 can be easily removed and cleaned by simply lifting the rollers from the U-shaped slots 124A formed in the support rails 124.

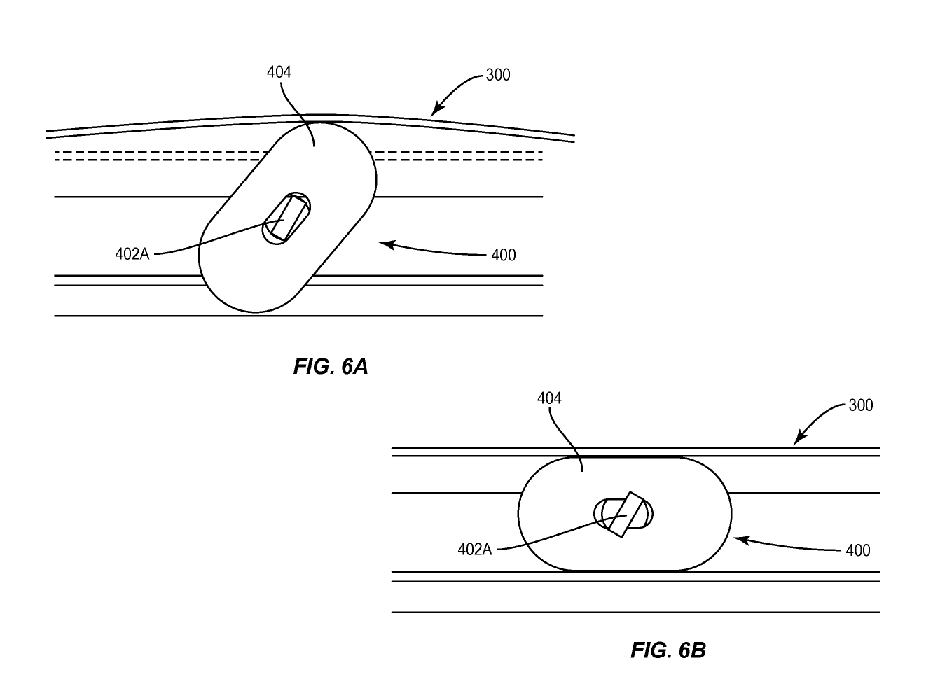

There is provided additional support for the upper run of the woven wire belt 300. In the case of the embodiment illustrated herein, a series of support devices is secured to the rails 124 and project inwardly therefrom a relatively short distance to support the outer edges of the upper run of the woven wire belt 316. This is illustrated in FIGS. 4, 6A, 6B, 7, 8A and 8B. These support devices are spaced between the upper rollers 316. Turning specifically to the embodiment illustrated herein, these support structures are referred to as conveyor edge supports and are indicated generally by the numeral 400. See FIG. 5. Each edge support 400 includes a shaft 402 that is seated or secured in any number of ways to a support rail 124. Shaft 402 projects inwardly therefrom and includes an outer key 402A. Disposed just inwardly of the outer key 402A is an annular support portion that supports a plastic support 404. Note in FIG. 5 where the plastic support 404 assumes a generally elongated shape having curved opposed ends and includes an elongated slot formed therein. The elongated slot of the support 404 is designed such that it can be easily fitted onto and removed from the shaft 402. In a normal operating mode as shown in FIG. 6B, it is seen that the key 402A is disposed at an angle to the elongated slot in the support 404. In this configuration, it is appreciated that the key 402A effectively retains the support 404 on the shaft 402. However, the support 404 can easily be removed from the shaft 402 by rotating the support, as shown in FIG. 6A, to where the elongated slot therein aligns with the key 402A. This enables the support 404 to be easily removed and cleaned and, thereafter, easily replaced on the support shaft 402. In a normal operating mode where the support 404 engages and supports an overlying edge of the woven wire belt 300, the upper edge thereof lies within one of the shallow channels formed in part by the weft wires 304. As noted above, in one embodiment the support 404 is formed of a plastic material. Because of the design of the conveyor edge support 400 and how it is supported, thermal expansion that may result from exposure to relatively high temperatures in the drying chamber will not adversely impact the function and operation of the edge support 404.

Conveyor assembly 110 also includes a series of longitudinally spaced lower rollers 320. For example, see FIGS. 4 and 5. Note that the end of each of the lower support rollers 320 is supported in a cantilevered support 122A that is secured to a vertical frame member 122. In the case of the embodiment illustrated herein, the lower support rollers 320 include flange bushings of the type discussed above and included on the outer ends of the upper rollers 316. As seen in the drawings, lower rollers 320 support the lower run of the wire belt 300. In this example, the number of upper rollers 312 exceeds the number of lower rollers 320. In the case of one embodiment, the lower rollers 320 are spaced approximately the same distance as the vertical frame members 122.

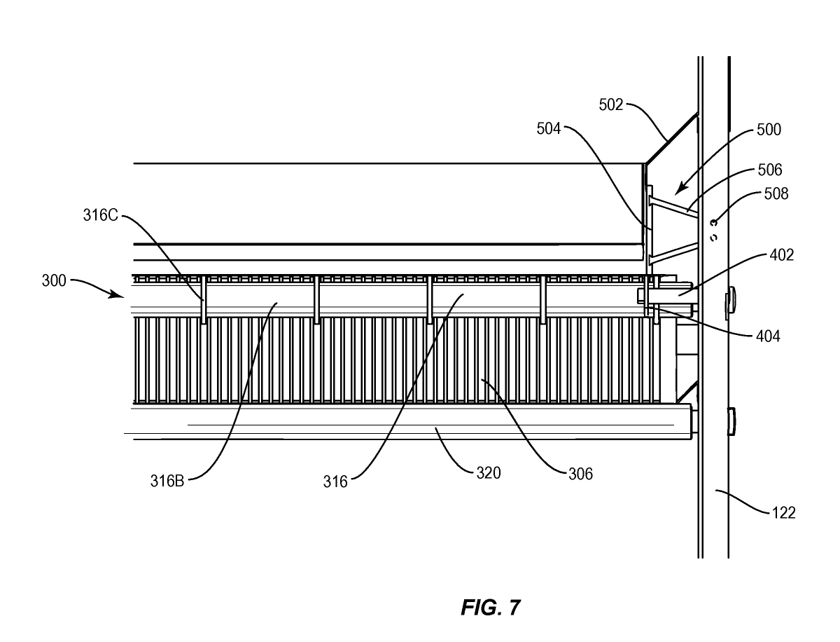

Disposed on each side of the upper run of the woven wire belt 300 is a series of side retainers indicated generally by the numeral 500. The function of the side retainers 500 disposed along each side of the woven wire belt 300 is to retain product on the conveyor assembly 110. With particular reference to FIGS. 7, 8A, 8B and 9, it is seen that the side retainers 500 are disposed generally beneath baffles 502 that are employed to encourage or direct air downwardly through the conveyor assembly 110. The side retaining structure described herein comprises a series of side retainers 500 secured to the vertical frame members 122 in end-to-end relationship. That is, the side retainers 500 are generally aligned and extend continuously along each side of the conveyor belt 300 as illustrated in FIGS. 8A, 8B and 9. Each side retainer 500 is pivotally mounted to two or adjacent vertical frame members 122 such that it can be moved from a normal operative position shown in FIG. 8A to a rotated position, such as shown in FIG. 8B, for cleaning purposes. Viewing one side retainer, it is seen that the same includes a retainer or elongated panel 504. Various materials can be used but in the case of one embodiment, the retainer 504 is made of PEEK material having impregnated glass. Each retainer 504 is secured to a pair of vertical frame members 122 by a pair of pivot brackets 506. Each bracket 506 is pivotally mounted to a vertical frame member 122 via a pivot pin 508. Bracket 506 is locked into a normal operating mode or configuration by a key 510 that extends through an opening in the vertical frame member 122 and into an opening in the bracket 506. Bracket 506 is dovetailed into an end portion of the retainer 504. See FIG. 9. Thus, there can be relative movement between the connecting points of the brackets 506 and the retainer 504. This feature compensates for thermal expansion of the retainer 504 and avoids the adverse effects of thermal expansion. Note in the normal operative mode as shown in FIG. 8, that the lower edge of the retainer 504 lies very close to the upper surface of the woven wire belt 300. This will prevent product from escaping between the upper surface of the belt 300 and the lower edge of the retainer 504. FIG. 8B shows the side retainer 500 rotated clockwise to a position that enables the side retainer 500 to be cleaned as well as enabling the upper surface of the conveyor belt 300 to be cleaned along the edges thereof.

The conveyor assembly 110 includes many advantages over conventional convey systems found in commercial and industrial dryers. The conveyor assembly 110 disclosed herein minimizes sanitation risks. This is accomplished by numerous design features. Many of the components of the conveyor system are designed in such a fashion that they do not attract and hold small particles that emanate from the product being dried. Moreover, many of the components that form the conveyor assembly 110 can quickly and easily be completely removed from the conveyor assembly. For example, the support rollers 316 and 320 can be completely removed, as well as the side edge supports 404. In addition, the side retainers 504 can be pivoted to a cleaning position. All of this allows easy and convenient access to the woven wire belt 300 for cleaning.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A dryer for drying product, comprising:
a housing;
a drying chamber formed in the housing of the dryer;
a burner unit for heating air used to dry the product;
a fan for circulating heated air through the drying chamber;
a chainless conveyor assembly disposed in the drying chamber for moving the product through the drying chamber, the chainless conveyor assembly including:
(i) an endless woven wire belt;
(ii) a drive drum disposed at one end of the conveyor assembly and having the woven wire belt trained therearound for driving the endless woven wire belt; and
(iii) a tensioning drum disposed on the other end of the chainless conveyor assembly for tensioning the woven wire belt.

2. The dryer of claim 1 including a series of side retainers disposed on opposite sides of the conveyor assembly, each side retainer being pivotally mounted to a frame structure for movement between an operative position where the side retainer lies closely adjacent the wire belt to an elevated position where the side retainer is spaced from the wire belt.

3. The dryer of claim 1 including a series of longitudinally spaced edge supports for engaging and supporting opposed edge portions of an upper run of the woven wire belt.

4. The dryer of claim 3 wherein each edge support includes a shaft and a plastic support secured on the shaft where the plastic support includes an edge that engages and supports the underside of the wire belt.

5. The dryer of claim 1 wherein the woven wire belt includes a plurality of strands of wire woven together to form a flexible woven belt, the strands of wire being connected together forming spaces between the strands of wire that enable air to pass through the woven wire belt.

6. The dryer of claim 1 wherein the woven wire belt includes a multiplicity of warp wires that are spaced in side-by-side relationship and wherein the warp wires are woven into laterally spaced weft wires.

7. The dryer of claim 6 wherein the warp wires form an upper surface of the woven wire belt and extend transversely across the conveyer assembly; and wherein the weft wires are disposed on the bottom of the woven wire belt and are laterally spaced and extend generally longitudinally with respect to the woven wire belt.

8. The dryer of claim 7 wherein the warp wires undulate across the conveyor assembly and extend downwardly and around selected weft wires.

9. The dryer of claim 6 wherein the warp wires include ends and wherein some of the ends of the warp wires are connected and some of the ends of the warp wires are not connected.

10. The dryer of claim 1 wherein the drive drum includes a plurality of groves for receiving U-shaped wire segments formed on the underside of the woven wire belt.

11. The dryer of claim 10 wherein the woven wire belt includes transverse warp wires and longitudinally extending weft wires, and wherein the U-shaped wire segments are formed by the transverse warp wires extending down and at least partially around the longitudinally extending weft wires.

12. The dryer of claim 1 including a plurality of support rollers that underlie and support an upper run of the woven wire belt; and wherein each support roller includes a series of ring guides that extend around the support roller and run in longitudinal groves formed on the underside of the upper run of the woven wire belt.

13. The dryer of claim 12 wherein the woven wire belt includes a plurality of transverse warp wires woven into longitudinally extending and laterally spaced weft wires; and wherein the grooves formed on the underside of the upper run of the woven wire belt are formed by the weft wires and a portion of the warp wires that extend around at least a portion of the weft wires.

14. The dryer of claim 1 including a plurality of support rollers that underlie and support an upper run of the woven wire belt; and wherein each support roller includes a self-lubricating bushing disposed on opposed end portions thereof that are received and supported by open top slots formed in a frame structure in the dryer.

15. The dryer of claim 1 wherein the conveyor assembly includes a series of edge supports for supporting opposed edge portions of an upper run of the woven wire belt; each edge support being rotatively mounted on a shaft supported by a frame structure in the dryer wherein the shaft projects inwardly from the frame structure towards the woven wire belt; and wherein each edge support is generally elongated and includes opposed curve-shaped ends.

16. The dryer of claim 1 wherein the conveyor assembly includes a series of edge supports for supporting opposed edge portions of an upper run of the woven wire belt; each edge support being rotatively mounted on a shaft supported by a frame structure in the dryer; and wherein each edge support is constructed of a plastic material and engages an underside edge portion of the upper run of a woven wire belt.

17. The dryer of claim 16 wherein the plastic edge support includes an elongated opening and wherein the shaft supporting the plastic edge support extends through the elongated opening; and wherein associated with the shaft is a key that is misaligned with the elongated opening in the plastic support in a normal operating mode so as to effectively retain the plastic edge support on the shaft, but wherein the plastic edge support can be rotated with respect to the shaft such that the elongated opening in the plastic edge support and the key is aligned such that the plastic edge support can be removed from the shaft.

18. The dryer of claim 2 wherein each side retainer includes a retaining structure and moveable bracket supporting the retaining structure and wherein the bracket is dovetailed into the retaining structure to permit relative movement between the retaining structure and the bracket due to thermal expansion.

19. A method of drying a product in a dryer having a drying chamber and a woven wire belt, comprising:
placing the product to be dried on the woven wire belt;
moving the woven wire belt through the drying chamber of the dryer;
circulating a system of heated air through the drying chamber; and
directing at least a portion of the heated system of air through the woven wire belt such that air passes between woven strands of wire and in the process contacts the product supported on the woven wire belt and dries the product.

20. The method of claim 19 including directing at least a portion of the air between transversely extending warp wires that are woven into a plurality of longitudinally extending weft wires.

21. The method of claim 20 including driving the woven wire belt with a drum roller and aligning the weft wires with grooves formed in the drum roller such that as the drum roller rotates, the weft wires of the woven wire belt align with the grooves in the drive roller.

22. The method of claim 19 wherein the dryer includes a series of side retainers disposed on each side of an upper run of the woven wire belt and the method includes raising the side retainers from an operative position where the side retainers lie closely adjacent an upper surface of the woven wire belt to an elevated position where the side retainers are spaced from the woven wire belt.

23. The method of claim 22 wherein each side retainer includes a retaining structure and a mounting bracket that is secured to the retaining structure, and the method includes permitting relative movement between the retaining structure and the bracket due to thermal expansion.

24. The method of claim 19 including supporting the outer edges of an upper run of the woven wire belt by engaging the underside of the upper run with a plastic support.

25. The method of claim 24 including rotating the plastic support on a support shaft such that an upper edge of the plastic support engages an upper run of the woven wire belt.

26. The method of claim 19 including:
supporting an upper run of the woven wire belt the series of removable rollers disposed underneath the upper run; and
guiding the woven wire belt as the woven wire belt moves through the drying chamber with guide rings disposed on the rollers by positioning the guide rings such that the guide rings run in channels formed on the underside of the upper run of the woven wire belt.

27. The method of claim 26 including positioning the guide rings of the rollers in channels formed by segments of warp wires that at least partially extend around longitudinally extending weft wires.

28. The dryer of claim 19 wherein the woven wire belt is chainless.

29. The dryer of claim 1 including a plurality of support rollers that underlie an upper run of the woven wire belt and which are removable from a support structure that supports the rollers; and wherein the support structure includes a plurality of open top cutouts that receive and support a portion of the rollers and which enables the rollers to be removed from the frame structure by lifting the rollers upwardly out of the open top cutouts.

30. A dryer for drying product, comprising:
a housing;
a drying chamber formed in the housing of the dryer;
a burner unit for heating air used to dry the product;
a fan for circulating heated air through the drying chamber;
a conveyor assembly disposed in the drying chamber for moving the product through the drying chamber, the conveyor assembly including:
(i) an endless woven wire belt;
(ii) a drive drum disposed at one end of the conveyor assembly and having the woven wire belt trained therearound for driving the endless woven wire belt;
(iii) a tensioning drum disposed on the other end of the conveyor assembly for tensioning the woven wire belt;
(iv) a series of side retainers disposed on each side of the woven wire belt for retaining the product on the woven belt as the woven wire belt moves through the drying chamber;
(v) each side retainer including a retaining structure having a lower edge that, in an operative mode, is disposed immediately adjacent a top surface of an upper run of the woven wire belt and wherein the retaining structure extends generally vertically with respect to the upper run of the woven wire belt; and
(vi) a moveably mounted support bracket attached to the retaining structure and extending therefrom and which is connected to a frame structure in the drying chamber, and wherein the support bracket is operative to raise the retaining structure from a position immediately adjacent the woven wire belt to an elevated position where the retaining structure is spaced from the woven wire belt.

31. The dryer of claim 30 wherein the retaining structure is a generally flat elongated panel; and wherein the support bracket is pivotally mounted to the frame structure in the drying chamber and is operative to swing the retaining structure from a position immediately adjacent the upper run of the woven wire belt to the elevated position.
